(19) United States
(12) Patent Application Publication
(10) Pub. No.: US 2026/0330769 A1
(43) Pub. Date: Oct. 22, 2026

(54) THREE-DIMENSIONAL DATA REDUCTION APPARATUS AND NON-TRANSITORY RECORDING MEDIUM

(71) Applicant: NTT DOCOMO, INC., Tokyo (JP)

(72) Inventor: Shiori YASUE, Chiyoda-ku (JP)

(73) Assignee: NTT DOCOMO, INC., Tokyo (JP)

(21) Appl. No.: 19/105,643

(22) PCT Filed: Aug. 1, 2023
(86) PCT No.: PCT/JP2023/028115

§ 371 Date: Feb. 21, 2025

(30) Foreign Application Priority Data
Sep. 7, 2022 (JP) 2022-142147

(51) Int. Cl. G06T 19/00

(52) U.S. Cl. CPC G06T 19/00

(57) ABSTRACT

A data reduction apparatus includes an acquirer, a recognizer, a divider, and a reduction processor. The acquirer acquires three-dimensional shape data representing a shape of a three-dimensional object. The recognizer recognizes a type of the object based on the three-dimensional shape data acquired by the acquirer. The divider divides, based on the type of the object recognized by the recognizer, the three-dimensional shape data into subsets, each corresponding to one of parts constituting the object. The reduction processor determines a data reduction amount of a subset for each of the parts, based on a table with reduction information representing a data reduction amount of each of the subsets, each corresponding to one of reference parts. The reduction processor reduces an amount of the three-dimensional shape data.

### TECHNICAL FIELD

The present disclosure relates to a three-dimensional data reduction apparatus that reduces an amount of three-dimensional shape data representing a shape of a three-dimensional object, and relates to a non-transitory recording medium.

### BACKGROUND ART

In general, a computer device, such as a home video game console, displays an image of a three-dimensional object based on three-dimensional shape data (hereinafter, “shape data”) representing a shape of an object. In some cases, a low-performance computer device, such as a glasses device (e.g., AR (Augmented Reality) glasses) or a smartphone, may not handle a large amount of shape data. However, as long as an amount of the shape data is appropriately reduced, even such a low-performance computer device will display images based on the shape data. Accordingly, in general, the amount of shape data is reduced. For example, Patent Document 1 discloses a technique that enables easy creation of CG data that is simplified depending on the intended use.

### RELATED ART DOCUMENT

### Patent Document

Patent Document 1: Japanese Patent Application Laid-Open Publication No. 2006-178661

### SUMMARY OF THE INVENTION

### Problem to Be Solved by the Invention

In general, a reduction ratio of shape data is set manually. The reduction ratio is a compression ratio of shape data, that is, data reduction amount, which is obtained by reducing the amount of the shape data. As the reduction ratio increases, the amount of the reduced shape data decreases. However, in an image displayed in accordance with the shape data after the reduction, fine shapes on the object surface are lost, and the image quality is degraded. Hereinafter, “fine shapes on the object surface” are referred to as “details of the object.” In some cases, reduction in the shape data may need a trial-and-error process, in which setting of the reduction ratio is changed, and reduction is repeated while the amount of the shape data after the reduction and the quality of an image displayed based on the reduced shape data are checked. Large amounts of shape data takes more time for a single reduction, which remains a challenge, taking a long time until an optimum reduction result is obtained in view of the image quality and data amount.

### Means of Solving the Problems

A three-dimensional data reduction apparatus according to a preferred aspect of the present invention is a reduction apparatus that reduces an amount of three-dimensional shape data representing a shape of a three-dimensional object. The reduction apparatus includes an acquirer, a recognizer, a divider, and a reduction processor, described below. The acquirer acquires three-dimensional shape data representing a shape of a three-dimensional object. The recognizer recognizes a type of the object based on the three-dimensional shape data. The divider divides, based on the recognized type of the object, the three-dimensional shape data into subsets, each corresponding to one of parts constituting the object. The reduction processor determines a data reduction amount of a subset for each of the parts, based on a table with reduction information representing a data reduction amount of each of the subsets, each corresponding to one of reference parts. Furthermore, the reduction processor reduces an amount of the three-dimensional shape data.

A non-transitory recording medium according to a preferred aspect of the present disclosure is a non-transitory recording medium having recorded therein a program that causes a computer to perform a method. The method includes: acquiring three-dimensional shape data representing a shape of a three-dimensional object; recognizing a type of the object based on the three-dimensional shape data; dividing, based on the recognized type of the object, the three-dimensional shape data into subsets, each corresponding to one of the parts constituting the object; determining a data reduction amount of a subset for each of the parts, based on a table with reduction information representing a data reduction amount of each of the subsets, each corresponding to one of the parts, and reducing an amount of the three-dimensional shape data.

### Effect of the Invention

According to the reduction apparatus and the non-transitory recording medium according to the present disclosure, fine reduction in data amount for each part can be realized based on the data reduction amount set in a table for each of parts constituting an object. Setting of contents of the table based on an intended use of shape data, that is, based on an application that uses the shape data, does not need trial and error in which reduction in the shape data is repeated while the reduction data amount of each part is changed. Furthermore, an optimum result of reduction for the application in view of the image quality and data amount can be obtained.

### BRIEF DESCRIPTION OF THE DRAWINGS

FIG. 1 is a block diagram showing an example of a configuration of a reduction apparatus 10 according to an embodiment of the present disclosure.

FIG. 2 is a diagram showing a monster figure OB1 as an example of a three-dimensional object.

FIG. 3 is a diagram showing an example in which the monster figure OB1 is divided into parts.

FIG. 4 is a diagram showing an example of a parts table TBL1 stored in a storage device 140 of the reduction apparatus 10.

FIG. 5 is a flowchart showing a flow of a reduction method performed by a processing device 150 of the reduction apparatus 10 in accordance with a program PR1.

FIG. 6 shows that a chair OB2 (an example of a three-dimensional object) is divided into parts.

FIG. 7 shows correction of the monster figure OB1 divided into parts.

FIG. 8 shows update of the parts table TBL1.

FIG. 9 is a diagram showing an example of a parts table TBL2.

### MODES FOR CARRYING OUT THE INVENTION

### A. Embodiment

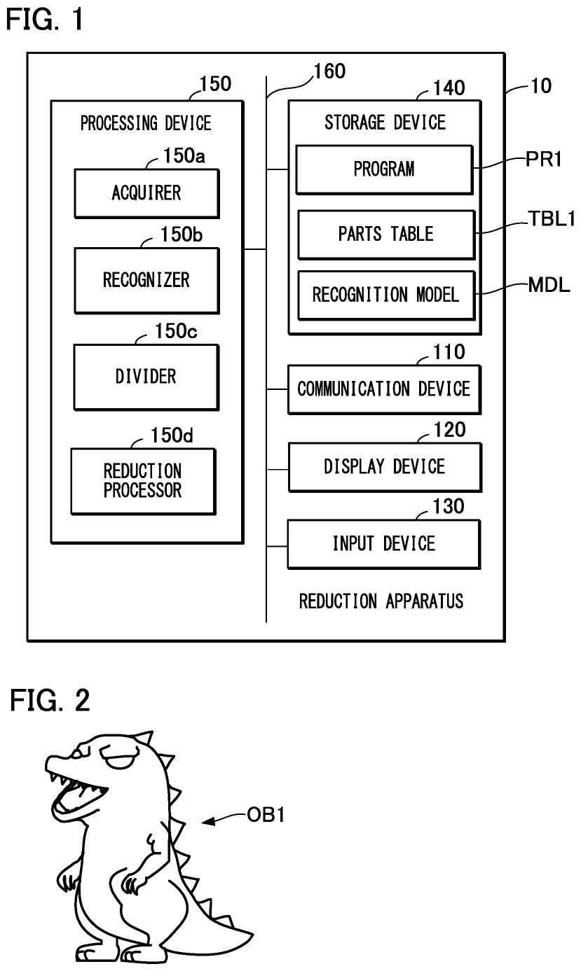

FIG. 1 is a block diagram showing an example of a configuration of a reduction apparatus 10 according to an embodiment of the present disclosure. The reduction apparatus 10 is a three-dimensional data reduction apparatus that reduces an amount of three-dimensional shape data (hereinafter, “shape data”) representing a shape of a three-dimensional object. The object according to the present embodiment is not limited to a real object in a real-world view. The object according to the present embodiment may include a virtual object displayed to be superimposed on a real-world view. The shape data according to the present embodiment is an aggregate of pieces of data, each representing one of the primitives when the surface of an object is represented by a set of the primitives, such as a polygon. Examples of data representing a primitive include data representing coordinates of each vertex of the primitive, and data representing a color applied to the primitive. Reduction in an amount of shape data means reduction in the number of primitives constituting the surface of an object by replacing plural primitives adjacent to each other with a larger primitive. Since the number of primitives constituting the surface of the object are reduced, image quality of the object displayed based on the shape data after the reduction is decreased relative to that before the reduction.

Examples of shape data to be reduced by the reduction apparatus 10 include shape data of a virtual object displayed to be superimposed on a real-world view in AR. When the shape data of the virtual object in AR is reduced, the shape data reduced by the reduction apparatus 10 is stored in a server apparatus that provides AR glasses with a contents management service. The contents management service refers to a service for acquiring location information indicating the location of AR glasses on a global coordinate system and that distributing virtual object information related to virtual objects in vicinity of the location indicated by the location information. The virtual object information includes shape data of each virtual object, and information indicating the arrangement location of the virtual object and the orientation thereof. The shape data after reduction by the reduction apparatus 10 is included in the virtual object information.

The reduction apparatus 10 divides shape data to be reduced into subsets. Specifically, a three-dimensional object represented by the shape data is composed of parts. The reduction apparatus 10 divides the shape data into subsets, each corresponding to one of the parts. The reduction apparatus 10 then reduces, for each part, an amount of the shape data on the basis of a table with reduction information. The reduction information indicates data reduction amount obtained by reduction. As illustrated in FIG. 1, the reduction apparatus 10 includes a communication device 110, a display device 120, an input device 130, a storage device 140, a processing device 150, and a bus 160. The communication device 110, the display device 120, the input device 130, and the storage device 140 and the processing device 150 are each interconnected by the bus 160 for transferring data. The bus 160 may be a single bus, or it may be constituted of more than one bus differing according to components connected thereto.

The communication device 110 is hardware (a transmitting and receiving device) for communicating with another apparatus. Another apparatus that communicates with the reduction apparatus 10 is connected to the communication device 110 in a wired or wireless manner. Examples of another apparatus connected to the communication device 110 include a server apparatus that provides a contents management service in AR, and a supply apparatus that supplies shape data to be reduced to the reduction apparatus 10. Examples of the supply apparatus include a 3D scanner that three-dimensionally scans a three-dimensional object to output three-dimensional shape data representing the shape of the object, and a CAD (Computer-Aided Design) device that draws a 3D model representing a three-dimensional object and outputs shape data based on the 3D model.

The display device 120 may be a liquid crystal display. The display device 120 displays a variety of images under control of the processing device 150.

The input device 130 may include a keyboard including keys (operators), and a pointing device, such as a mouse. The input device 130 receives an input operation from a user, such as pressing of any of the keys, or drag and drop using the pointing device. The input device 130 outputs operation data indicating details of the received input operation to the processing device 150. As a result of the output, the details of the input operation made by the user are transmitted to the processing device 150. In the present embodiment, examples of the input operation for the input device 130 include an input operation to instruct correction of a result obtained when a three-dimensional object represented by shape data to be reduced is divided into parts, and an input operation to register reduction information that specifies reduction of each part.

The storage device 140 is a recording medium readable by the processing device 150. The storage device 140 may comprise at least one of a ROM (Read Only Memory), an EPROM (Erasable Programmable ROM), an EEPROM (Electrically Erasable Programmable ROM), and a RAM (Random Access Memory). A recognition model MDL, a parts table TBL1, and a program PR1 are pre-stored in the storage device 140.

The recognition model MDL is a distinguisher that recognizes a type of a three-dimensional object (hereinafter, “recognition target”) represented by shape data to be input to the reduction apparatus 10. The recognition model MDL may be a distinguisher that recognizes a type of an object by feature amount matching, or it may be a distinguisher generated by deep learning. Examples of the deep learning include “YOLO,” “faster RCNN,” and “Mask RCNN.” Hereinafter, a distinguisher that recognizes the type of an object by feature amount matching is referred to as “first distinguisher.” A distinguisher generated by deep learning is referred to as “second distinguisher.”

The first distinguisher is pre-generated by an apparatus other than the reduction apparatus 10. Specifically, as teaching data, a pair of the following is set: (i) known shape data and (ii) a label indicating the type of a three-dimensional object represented by the known shape data. The amount of features of the three-dimensional object represented by the known shape data is associated with a label for each of the types of object. By repeating such process, the first distinguisher is generated. An advantage of the first distinguisher is that the time required for the generation is short. Even for the large number of pieces of teaching data, generation of the first distinguisher will be completed in approximately several minutes. A disadvantage of the first distinguisher is that it may fail to detect a recognition target. Such a case may occur when a recognition target of the shape data comprises more than one object with a three-dimensional shape. For example, a backdrop region of an image, generated by projecting a three-dimensional object represented by shape data onto a certain plane, is relatively large. Hereinafter, an image generated by projecting a three-dimension object represented by shape data onto a certain plane is referred to as “image generated based on shape data.”

The second distinguisher is pre-generated by an apparatus other than the reduction apparatus 10. In generation of the second distinguisher, a Bounding Box and teaching data are used. The teaching data is given a ground-truth label indicating the name of a recognition target or a part thereof bounded by the Bounding Box. The Bounding Box is a rectangular region (box) for bounding a recognition target or each of parts constituting the recognition target in an image generated based on shape data. The second distinguisher learns features of the recognition target through multiple learning steps according to a hierarchical structure. The first advantage of the second distinguisher is that a region occupied by the recognition target in an image generated based on the shape data of the recognition target is determined. The second advantage is that the second distinguisher is more tolerant of changes due to environmental factors than the feature amount matching. In association with the second advantage, the following is envisaged: (i) a portion of the recognition target in an image generated based on the shape data of the recognition target is masked, (ii) the recognition target is slightly deformed, and (iii) the tone of the recognition target differs from the original tone due to the influence of an imaging environment (for example, whether there is outside light). Even such cases, the probability of recognition is greater than that of the first distinguisher although the type of the recognition target is not 100% recognizable. The second distinguisher has the following two disadvantages. The first disadvantage is that a certain time is required to generate the distinguisher, that is, to complete learning. The second disadvantage is that the probability of occurrence of false recognition is greater than that of the first distinguisher. False recognition means that the type of a recognition target is erroneously recognized because the target is recognized as an already-learned object even though the target is not an already-learned object. False recognition may occur in the first distinguisher; however, the probability of occurrence therein is less than that in the second distinguisher.

In the present embodiment, the second distinguisher is adopted as the recognition model MDL. The recognition model MDL according to the present embodiment may be generated by any method of “YOLO,” “faster RCNN,” and “Mask RCNN” described above. Alternatively, the recognition model MDL may be generated by deep learning that is different from these three methods. The recognition model MDL according to the present embodiment can divide a recognition target into parts constituting the recognition target as well as recognizing the type of the recognition target. Specifically, the recognition model MDL divides a recognition target into parts by outputting region information and part information for each of the parts. As described above, an object included in an image generated based on input shape data consists of plural parts. The region information output for each part indicates the range of a region occupied by this part among the parts constituting the object. The part information indicates the corresponding part. Examples of the part information include a character string representing the name of a part and a sequence number assigned to a part.

The recognition model MDL according to the present embodiment is generated by deep learning using teaching data related to a variety of figures of a monster, a robot, an animal, and the like. With the use of this recognition model MDL, based on shape data representing a shape of a three-dimensional figure of a monster, a robot, or an animal, the reduction apparatus 10 can recognize the type of the figure and can divide the shape data for each of parts constituting the figure. Hereinafter, each piece of the shape data divided for each part is referred to as “subset.”

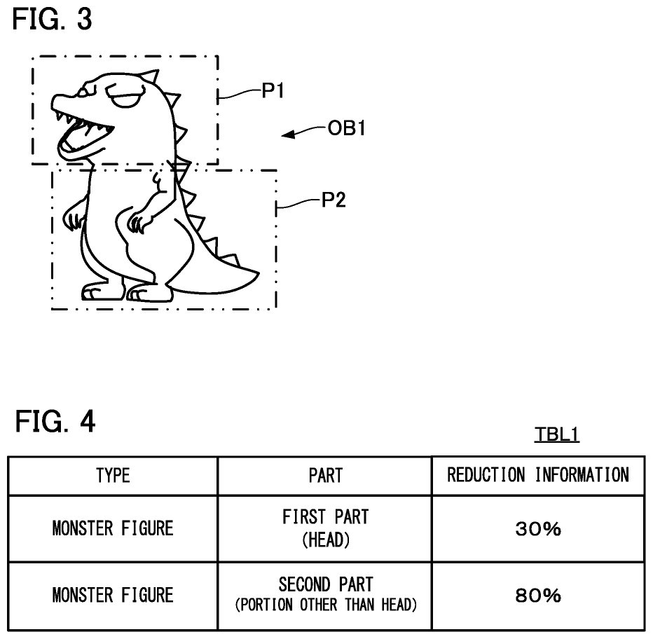

For example, a monster figure OB1 is illustrated in FIG. 2. When shape data representing the shape of the three-dimensional figure OB1 is reduced, the type of the figure OB1 is recognized as “monster” with the use of the recognition model MDL. As illustrated in FIG. 3, the figure OB1 is divided into a first part P1 and a second part P2. The first part P1 corresponds to the head of the monster. The second part P2 corresponds to a portion other than the head of the monster. In the present embodiment, first, the coordinates of the vertexes of each of primitives represented by the shape data are converted to the coordinates in an image generated based on the shape data. A part to which each primitive belongs out of the first part P1 and the second part P2 is determined based on the converted coordinates and the region information output from the recognition model MDL. On the basis of the result of this determination, the shape data is divided into two subsets (data representing the shape of parts): a subset corresponding to the first part P1, and a subset corresponding to the second part P2.

The recognition model MDL according to the present embodiment is a distinguisher that recognizes the types of objects belonging to one category of the figure. However, the recognition model MDL may be a distinguisher that recognizes the types of objects in plural categories, for example, pieces of furniture, such as a chair or a table, in addition to figures. In this case, the distinguisher is generated by machine learning using teaching data related to furniture, as well as teaching data related to the figures.

FIG. 4 is a diagram showing an example of a parts table TBL1. The parts table TBL1 has the types of objects that are recognized by the recognition model MDL, parts (part information) constituting each of the objects, and reduction information related to the corresponding part. Each part included in the parts table TBL1 is an example of a reference part. In the present embodiment, the reduction ratio is adopted as the reduction information. The reduction ratio according to the present embodiment is a value obtained by expressing the number of reduced primitives as a percentage assuming that the total number of primitives constituting the part before reduction is 100. A greater reduction ratio means that the data reduction amount is greater. The reduction ratio of a part is determined based on the importance of the part in the object. In the present embodiment, the importance of a part is determined according to the likelihood of the sightline of the user being placed on the part. In the present embodiment, a part on which the sightline of the user is more likely to be placed has a higher importance, and the reduction ratio is smaller.

The importance according to the present embodiment is set based on results of experiments in which the gaze duration in which the user places the sightline on each part when the user sees an object is measured. As the gaze duration is longer, the importance is higher, that is, the reduction ratio is smaller. For example, the reduction ratio of a part of which the gaze duration is less than one second is set to 80. The reduction ratio of a part of which the gaze duration is equal to or greater than one second and is less than three seconds is set to 50. The reduction ratio of a part of which the gaze duration is equal to or greater than three seconds is set to 30. The relation between the gaze duration of a part and the reduction ratio may be appropriately set according to the type of an application using shape data, for example, an application for AR or for a home video game console. The reduction ratio may decrease in linear-proportion to the length of the gaze duration.

An example in FIG. 4 is given of the parts table TBL1 when a three-dimensional object represented by shape data is a monster figure. FIG. 4 shows that the monster figure consists of two parts including a “head” and a “portion other than the head.” FIG. 4 also shows that the reduction ratio of the “head” is 30 and the reduction ratio of the “portion other than the head” is 80.

It is known that, not only in a monster figure, but also in any figure, that the sightline of the user is likely to be placed on the “head” including the “face.” In the present embodiment, the reduction ratio of the “head” is less than that of the “portion other than the head.” Accordingly, in an image of the monster figure OB1 displayed in accordance with reduced shape data, degradation of the image quality of the head is less than that of the portion other than the head. Since the degradation of the image quality of the head on which the sightline is likely to be placed is less, the user is less likely to perceive the degradation of the image quality caused by the reduction. This is because the reduction ratio is smaller for a part having a higher importance, that is, a part on which the sightline of the user is more likely to be placed.

The reduction information according to the present embodiment indicates a reduction ratio. However, the reduction information may be (i) a threshold related to the number of vertexes included in a part, (ii) a threshold related to the number of primitives constituting a part, or (iii) a threshold related to the amount of a subset corresponding to a part. Examples of the threshold related to the number of vertexes included in a part include a recommended value or an upper limit determined in advance in a service provided using shape data. For a case indicated by (i) (the threshold related to the number of vertexes included in a part), a difference between the number of vertexes represented by a subset before reduction and the threshold represented by the reduction information refers to the data reduction amount for a part corresponding to this subset. Also in this case, the reduction information is set such that the number of vertexes is reduced in a part with a higher importance. The same holds for a case indicated by (ii) (the threshold related to the number of primitives) and a case indicated by (iii) (the threshold related to the data amount). These thresholds are often defined as requirements in a service provided using shape data. The thresholds may be defined with respect to each part on the basis of a combination of the likelihood of the sightline being placed on the part and the requirements defined in the service.

The processing device 150 comprises one CPU (Central Processing Unit) or multiple CPUs. The processing device 150 reads the program PRI from the storage device 140 in response to power supply of the reduction apparatus 10. The processing device 150 executes the read program PR1. By executing the program PR1, the processing device 150 acts as an acquirer 150a, a recognizer 150b, a divider 150c, and a reduction processor 150d illustrated in FIG. 1. That is, the acquirer 150a, the recognizer 150b, the divider 150c, and the reduction processor 150d illustrated in FIG. 1 are software modules realized by actuation of a computer, such as a CPU in accordance with software, such as a program. Functions served by these components are as follows.

The acquirer 150a communicates with the supply apparatus using the communication device 110, to acquire shape data from the supply apparatus.

The recognizer 150b recognizes the type of a three-dimensional object represented by the shape data acquired by the acquirer 150a on the basis of the shape data using the recognition model MDL. The recognizer 150b acts to manage the recognition model MDL. The managing function includes editing of teaching data for generating the recognition model MDL and execution of machine learning using the teaching data.

The divider 150c implements first division process or second division process to one piece of shape data. The first division process is implemented to divide shape data into plural subsets on the basis of the type of an object recognized by the recognizer 150b. In the first division process, the divider 150c determines to which part each primitive represented by the shape data belongs on the basis of the region information output from the recognition model MDL, thereby classifying each primitive according to parts. With this classification, the divider 150c divides the shape data into subsets for each part.

The second division process is implemented when the recognizer 150b fails to recognize the type of an object. In the second division process, the divider 150c determines that primitives being adjacent to each other and having the same or similar color belong to the same part, and classifies primitives represented by shape data into corresponding groups. With this classification, the recognizer 150b divides the shape data into subsets, each corresponding to one of groups. When plural groups are provided by plural primitives being adjacent to each other and having the same or similar color, one group is provided in a manner described below. For example, the color of each primitive is expressed by the intensities of colors of R (Red), G (Green), and B (Blue). In this case, with respect to each of the colors R, G, and B for each primitive belonging to the same group, a group is provided such that a difference between (i) a value representing the intensity of the color, and (ii) the average of associated values of all the primitives belonging to this group is less than a predetermined threshold.

The reduction processor 150d generates shape data in which a data amount of each subset is reduced on the basis of the result of the division by the divider 150c and the parts table TBL1. As described above, reduction according to the present embodiment refers to a reduction in the number of primitives constituting the surface of an object by replacing primitives adjacent to each other with a larger primitive. The reduction processor 150d multiplies, for each subset, the total number of primitives constituting the surface of the part by a value in percentage (for example, 80/100 when the reduction ratio is 80) indicated by the reduction information (the reduction ratio) of this part. The reduction processor 150d replaces as many primitives as a value obtained by the multiplication in the manner described above. Such a replacement reduces the amount of the shape data.

Upon reception of an instruction of correction of the result of the division from an input operation of the input device 130, the reduction processor 150d corrects the subsets divided by the divider 150c (correction process), and subsequently reduces the amount of the shape data. In the correction process according to the present embodiment, the user moves a Bounding Box based on GUI as Gizmo, or performs addition or elimination of a Bounding Box, thereby correcting the division result of parts. When subsets obtained from shape data as a reduction target include a subset corresponding to a part unregistered in the parts table TBL1, the reduction processor 150d performs table update process to update the parts table TBL1 and subsequently reduces the amount of the shape data. Details of the update of the parts table TBL1 are determined by the user.

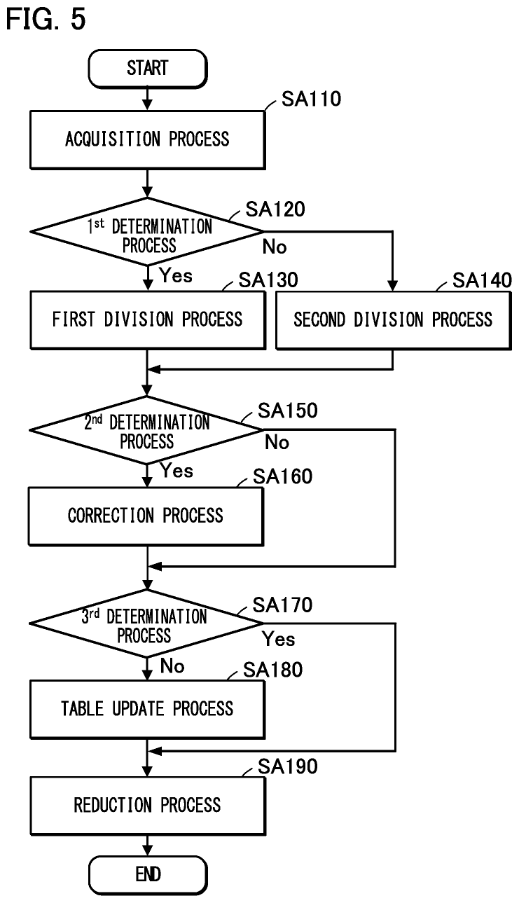

The processing device 150 running the program PR1 executes a method for reduction illustrated in FIG. 5. In an acquisition process SA110, the processing device 150 acts as the acquirer 150a. In the acquisition process SA110, the processing device 150 communicates with the supply apparatus using the communication device 110, to acquire shape data from the supply apparatus by communicating.

In first determination process SA120, the processing device 150 functions as the recognizer 150b. In the first determination process SA120, the processing device 150 determines whether the type of an object with a three-dimensional shape represented by the shape data acquired in the acquisition process SA110, that is, the type of a recognition target, is recognizable using the recognition model MDL. When the type of the recognition target has been recognized using the recognition model MDL, the result of the first determination process SA120 is “Yes (affirmative).” In contrast, when the type of the recognition target has not been recognized using the recognition model MDL, the result of the first determination process SA120 is “No (negative).”

When the result of the first determination process SA120 is “Yes,” the processing device 150 acts as the divider 150c and executes first division process SA130. When the result of the first determination process SA120 is “No,” the processing device 150 acts as the divider 150c and executes second division process SA140.

For example, it is envisaged that a monster figure OB1 is recognized in FIG. 2. As described above, the recognition model MDL according to the present embodiment is generated by deep learning using teaching data related to a variety of figures of a monster, a robot, an animal, and the like. Accordingly, when the monster figure OB1 illustrated in FIG. 2 is a recognition target, the processing device 150 can recognize that the type of the recognition target is a “monster” using the recognition model MDL. As a result, the result of the first determination process SA120 is “Yes,” and the first division process SA130 is performed. In the first division process SA130, the shape data representing the three-dimensional shape of the recognition target is divided into a subset corresponding to the first part P1 and a subset corresponding to the second part P2 illustrated in FIG. 3 on the basis of the result of the determination with the recognition model MDL.

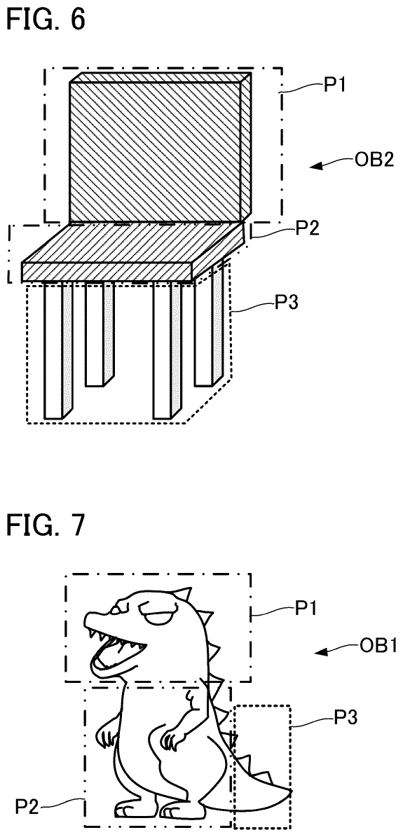

In contrast, when a chair OB2 illustrated in FIG. 6 is a recognition target, the type of this recognition target cannot be recognized using the recognition model MDL. Accordingly, the result of the first determination process SA120 is “No,” and the second division process SA140 is performed. In the second division process SA140, the shape data is divided into subsets on the basis of colors of parts. For example, as illustrated in FIG. 6, the chair OB2 is divided into a first part P1 for the back portion, a second part P2 for the seating plate portion, and a third part P3 for the leg portion. As a result, the shape data of the chair OB2 is divided into three subsets, each corresponding to one of these three parts.

In second determination process SA150, the processing device 150 acts as the reduction processor 150d. In the second determination process SA150, the processing device 150 causes the display device 120 to display an image representing the result of division of the recognition target. Furthermore, the processing device 150 asks a user whether correction of the division result is required. Upon receipt of a response from the user, the processing device 150 determines whether correction of the result of the division is necessary. When the input device 130 receives an input operation to instruct correction of the result of the division, the result of the second determination process SA150 is “Yes.” In this case, the processing device 150 performs correction process SA160 and subsequently performs third determination process SA170. In contrast, when the input device 130 receives an input operation to instruct not to correct the result of the division, the result of the second determination process SA150 is “No.” In this case, the processing device 150 performs the third determination process SA170 without the correction process SA160.

For example, it is envisaged that, in FIG. 2, the monster figure OB1 is a recognition target. Furthermore, as illustrated in FIG. 3, it is envisaged that the shape data of the recognition target is divided into a subset for the head and a subset for the portion other than the head. In this case, in the second determination process SA150, the processing device 150 causes the display device 120 to display, for example, the image illustrated in FIG. 3 as an image indicating the result of the division. FIG. 3 shows that the monster figure OB1 is divided into two parts by two types of rectangles. One of the two parts is the first part P1 for the head part and is shown by a rectangle with a dash-dot line. The other part is the second part P2 for the portion other than the head and is shown by a rectangle with a dash-double dot line. When the input device 130 receives, from the user that has visually recognized the image illustrated in FIG. 3, an input operation to instruct correction of the result of the division, the result of the second determination process SA150 is “Yes,” and the processing device 150 performs the correction process SA160. Hereinafter, in the correction process SA160, as illustrated in FIG. 7, it is envisaged that a user's instruction for correction is to divide the shape data into (i) the first part P1 for the head, (ii) a second part P2 for the torso, and (iii) a third part P3 for the tail.

In the third determination process SA170, the processing device 150 acts as the reduction processor 150d. In the third determination process SA170, the processing device 150 determines whether all reduction information of parts for the subsets is registered in the parts table TBL1. When the reduction information of all the parts is registered in the parts table TBL1, the result of the third determination process SA170 is “Yes.” In contrast, when the reduction information of at least one part is unregistered in the parts table TBL1, the result of the third determination process SA170 is “No.”

When the determination result of the third determination process SA170 is “No,” the processing device 150 performs table update process SA180 and subsequently performs reduction process SA190. In contrast, when the result of the third determination process SA170 is “Yes,” the processing device 150 performs the reduction process SA190 without the table update process SA180. In the table update process SA180, the processing device 150 acts as the reduction processor 150d. The processing device 150 causes the display device 120 to display a screen to prompt the user to register reduction information related to a part of which the reduction information is unregistered. The processing device 150 registers the reduction information related to this part in the parts table TBL1 in accordance with an input operation to the input device 130.

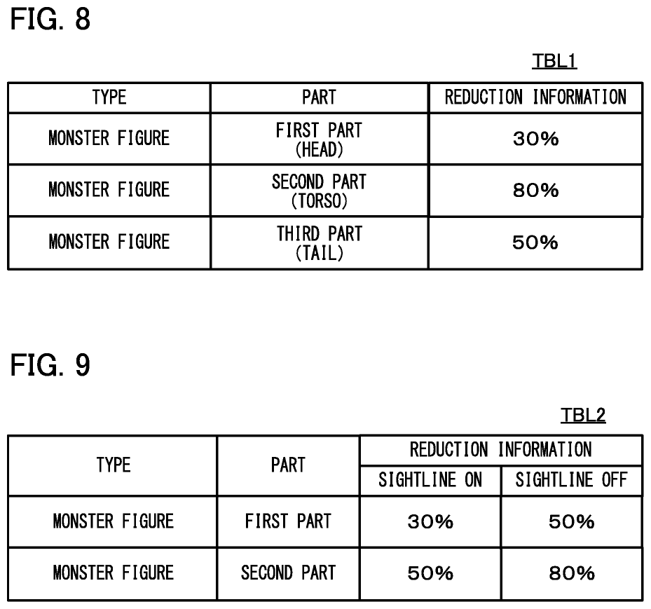

When the shape data is divided into three subsets (the first part P1, the second part P2, and the third part P3 illustrated in FIG. 7), the reduction information corresponding to the third part (that is, the reduction information corresponding to the tail of the monster figure) is unregistered in the parts table TBL1 illustrated in FIG. 4. Accordingly, the result of the third determination process SA170 is “No.” In this case, the table update process SA180 is performed. In the table update process SA180, the reduction information of the tail of the monster figure is additionally registered in the parts table TBL1 in accordance with an input operation to the input device 130. In consequence, the parts table TBL1 is updated as illustrated in FIG. 8. When the shape data is divided in the second division process SA140, reduction information corresponding to each of divided parts is unregistered in the parts table TBL1. The result of the third determination process SA170 is “No,” and the table update process SA180 is performed.

In the reduction process SA190, the processing device 150 acts as the reduction processor 150d. In the reduction process SA190, the processing device 150 determines a reduction ratio of each part on the basis of the parts table TBL1. The processing device 150 reduces a data amount of each subset on the basis of the reduction ratio of each part and generates reduced shape data. The reduced shape data is stored in a server apparatus that provides AR glasses with a contents distribution service, and is transmitted to the AR glasses from the server apparatus.

The AR glasses display the image of the monster figure OB1 to be superimposed on a real-world view in accordance with the reduced shape data. The amount of the shape data transmitted from the server apparatus to the AR glasses has been reduced as a whole, and no particular trouble occurs in data processing performed by the AR glasses.

Furthermore, in the present embodiment, the data amount of the subset for each part is reduced at the reduction ratio differing according to the parts of the monster figure OB1. The reduction ratio of the head is less than that of the torso and that of the tail. Accordingly, details of the head on which the sightline of the user is more likely to be placed when the image of the monster figure OB1 is displayed on the AR glasses are not greatly lost, as compared to details of each of the torso and the tail. The details of each of the torso and the tail are not completely omitted.

As described above, according to the present embodiment, the data amount can be finely reduced for each of parts constituting an object according to the importance of the part. As a result, it is possible to avoid details of a part having a high importance being greatly lost. Complete omission of a part having a low importance can also be avoided. Furthermore, trial and error, in which reduction of the shape data is repeated while the reduction ratio of each part is changed, is not needed with appropriate setting of the contents of the parts table TBL1 based on the type of an application that uses shape data, such as AR or a home game video console.

According to the present embodiment, when an amount of shape data representing a shape of a three-dimensional object is reduced, an optimum result of reduction for an application that uses the shape data in view of the image quality and the data amount of the application can be obtained without trial and error.

### B. Modifications

The present disclosure is not limited to the foregoing embodiment. Description will be given below of specific modifications of the embodiment. Two or more modes freely selected from the following examples may be combined with one another.

### B-1. First Modification

The recognition model MDL according to the foregoing embodiment is a distinguisher that recognizes which figure of a monster, a robot, and an animal a three-dimensional object represented by shape data is. For example, when shape data representing a shape of a three-dimensional object belonging to a category different from the figure, such as a chair or a table is input, false recognition may occur. In order to prevent such false recognition, the first determination process SA120 may be modified as follows.

In the first determination process SA120 according to the first modification, the processing device 150 asks a user whether the category of an object of which the type is recognized by the recognition model MDL matches the category that a three-dimensional object represented by input shape data belongs to. When the input device 130 receives an input operation indicating that both matches in response to this inquiry, the processing device 150 recognizes the type of the object using the recognition model MDL. In contrast, when the input device 130 receives an input operation indicating that both do not match, the processing device 150 settles a result of the determination as “No,” and ends the first determination process SA120. According to this modification, when a three-dimensional object represented by shape data acquired in the acquisition process SA110 is not an object belonging to a category of which the object type is recognized by the recognition model MDL, false recognition of the object type can be avoided.

### B-2. Second Modification

In the foregoing embodiment, the first division process SA130 or the second division process SA140 is performed based on the result of recognition of the type of an object using the recognition model MDL. However, when the type of an object is not recognized by the recognition model MDL, a manual division process may be performed by a user instead of the second division process SA140, similarly to the correction process SA160. It is also possible for the second division process SA140 to always be performed, without recognition of the type of an object using the recognition model MDL. In this case, the first determination process SA120 and the first division process SA130 are unnecessary.

### B-3. Third Modification

In the foregoing embodiment, the server apparatus that provides AR glasses with a content distribution service and the reduction apparatus 10 are different apparatuses. Shape data that has been reduced by the reduction apparatus 10 is stored in the server apparatus. However, the server apparatus and the reduction apparatus 10 may be unity. In this case, the server apparatus may store therein shape data before reduction and reduce an amount of the shape data at each time of distribution to AR glasses.

When the amount of the shape data is reduced at each time of distribution to AR glasses, the server apparatus may acquire, from the AR glasses, sightline information indicating a position of the sightline of the user of the AR glasses. Furthermore, the server apparatus sets reduction information based on a part on which the sightline of the user is positioned when an image of an object is displayed on the AR glasses. Specifically, the server apparatus with the function of the reduction apparatus 10 includes a parts table TBL2 illustrated in FIG. 9 instead of the parts table TBL1 illustrated in FIG. 4. In FIG. 9, reduction information corresponding to “sightline ON” represents the reduction ratio when the sightline of the user is positioned thereon. Reduction information corresponding to “sightline OFF” represents the reduction ratio when the sightline of the user is not positioned thereon.

A processing device of the server apparatus sets the reduction ratio of each part based on whether the sightline of the user is positioned thereon by referring to the sightline information and the parts table TBL2, and reduces the amount of the shape data in the reduction process SA190. For example, when the sightline of the user is positioned on the torso and when the image of the monster figure OB1 illustrated in FIG. 2 is displayed on AR glasses, the server apparatus determines the reduction ratio of the subset for the head as “50” and determines the reduction ratio of the subset for the torso as “50.” The server apparatus then distributes the reduced shape data to the AR glasses.

### B-4. Fourth Modification

In the foregoing embodiment, the program PR1 is stored in the storage device 140 of the reduction apparatus 10. However, the program PR1 may be produced or sold individually. Examples of aspects for providing a purchaser with the program PR1 at selling the program PR1 include (i) an aspect of writing the program PR1 to a computer-readable recording medium, such as a flash ROM, and distributing the medium, and (ii) an aspect of distributing the program PR1 by downloading through a telecommunication lines, such as the Internet. In the foregoing embodiment, the recognition model MDL and the parts table TBL1 are stored in the storage device 140. However, either one or both the recognition model MDL and the parts table TBL1 may be stored in a storage device that is accessible by the processing device 150 through a telecommunication line. While the importance of each part is set according to the likelihood of the sightline of a user being placed on the part in the above embodiment, the importance of each part may be set irrespective of the likelihood of the sightline of the user being placed on the part. For example, the importance of each part may be set based on the level of the part at which a creator of shape data assumes the part to be important.

### B-5. Fifth Modification

The acquirer 150a, the recognizer 150b, the divider 150c, and the reduction processor 150d according to the foregoing embodiment are all software modules.

However, one, two, three, or all of the acquirer 150a, the recognizer 150b, the divider 150c, and the reduction processor 150d may be hardware modules. Examples of the hardware module include a DSP (Digital Signal Processor), an ASIC (Application Specific Integrated Circuit), a PLD (Programmable Logic Device), and an FPGA (Field Programmable Gate Array). Even when at least one of the acquirer 150a, the recognizer 150b, the divider 150c, and the reduction processor 150d is a hardware module, this modification provides effects the same as those in the foregoing embodiment.

### C. Other Matters

(1) In the foregoing embodiment, as examples of the storage device 140, a ROM, a RAM, and the like have been described. However, the storage device 140 may be a flexible disk, a magneto-optical disk (for example, a compact disc, a digital versatile disc, or a Blu-ray (registered trademark) disc), a smart card, a flash memory device (for example, a card, a stick, or a key drive), a compact disc-ROM (CD-ROM), a register, a removable disk, a hard disk, a floppy (registered trademark) disk, a magnetic strip, a database, a server, or another appropriate storage medium.
(2) In the foregoing embodiments, the information, signal, or the like may be expressed by using any of various different techniques. For example, data, an order, a command, information, a signal, a bit, a symbol, a chip, or the like that can be referred to throughout the description above may be expressed by using a voltage, a current, electromagnetic waves, a magnetic field or a magnetic particle, a photo field or a photon, or any combination thereof.
(3) In the foregoing embodiments, information or the like that has been input or output may be stored in a specified place (for example, a memory), or may be managed by using a management table. The information or the like that has been input or output can undergo overwriting, updating, or postscript. The information or the like that has been output may be deleted. The information or the like that has been input may be transmitted to another apparatus.
(4) In the foregoing embodiments, determination may be performed on the basis of a value (0 or 1) expressed by using one bit, may be performed on the basis of a Boolean value (true or false), or may be performed on the basis of a comparison between numerical values (for example, a comparison with a predetermined value).
(5) In a processing procedure, a sequence, a flowchart, or the like that has been described as an example in the embodiments described above, the order may be changed without inconsistency. For example, in the method described in the present disclosure, various step elements have been provided by using an illustrative order, and the specified order that has been provided is not restrictive.
(6) The respective functions illustrated in FIG. 1 are implemented by any combination of at least one of hardware and software. A method for implementing respective function blocks is not particularly limited. Stated another way, the respective function blocks may be implemented by using a single physically or logically coupled device, or may be implemented by directly or indirectly (for example, in a wired manner, in a wireless manner, or the like) connecting two or more devices that are physically or logically separated, and using these plural devices. The function blocks may be implemented by a combination of the single device described above or the plural devices described above and software.
(7) The foregoing programs as an example in the embodiments described above are to be broadly construed as meaning of an order, an order set, a code, a code segment, a program code, a program, a sub-program, a software module, an application, a software application, a software package, a routine, a sub-routine, an object, an executable file, an execution thread, a procedure, a function, or the like, regardless of whether the programs are referred to as software, firmware, middleware, a microcode, a hardware description language, or another term.

Software, an order, information, or the like may be transmitted or received via a transmission medium. For example, when software is transmitted from a website, a server, or another remote source by using at least one of a wired technique (a coaxial cable, an optical fiber cable, a twisted-pair wire, a digital subscriber line (DSL), or the like) or a wireless technique (infrared rays, microwaves, or the like), at least one of these wired and wireless techniques falls under the definition of the transmission medium.
(8) In each of the embodiments described above, the terms “system” and “network” are compatibly used.
(9) The information, the parameter, or the like that has been described in the present disclosure may be expressed by using an absolute value, may be expressed by using a value relative to a predetermined value, or may be expressed by using other corresponding information.
(10) In the foregoing embodiment, mobile device may be a mobile station (MS) in some cases. In some cases, the mobile station is referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms by those skilled in the art. In the present disclosure, the terms “mobile station”, “user terminal”, “user equipment (UE)”, “terminal”, and the like can be compatibly used.
(11) In the foregoing embodiments, the terms “connected”, and “coupled”, or all transformations thereof mean all types of direct or indirect connection or coupling of two or more elements, and include that one or more intermediate elements exist between two elements that are “connected” or “coupled” to each other. Coupling or connection of elements may be physical coupling or connection, logical coupling or connection, or a combination thereof. For example, “connection” may be replaced with “access.” In the case of use in the present disclosure, it can be considered that two elements are “connected” or “coupled” to each other by using at least one of one or more electric wires, cables, and printed electric connection, and by using electromagnetic energy or the like having wavelengths of, as some non-limiting and non-comprehensive examples, a wireless frequency range, a microwave region, and a light (both visible and invisible) region.
(12) In the forgoing embodiments, the description “on the basis of” does not mean “solely on the basis of” unless otherwise specified. In other words, the description “on the basis of” means both “solely on the basis of” and “at least on the basis of”.
(13) The term “determining” used in the present disclosure includes a variety of operations in some cases. The “determining” can include, for example, that “judging”, “calculating”, “computing”, “processing”, “deriving”, “investigating”, “looking up, search, or inquiry” (for example, looking up, search, or inquiry of a table, a database, or another data structure), ascertaining is considered as “determining.” The term “determining” can include, for example, that “receiving” (for example, receiving information), “transmitting” (for example, transmitting information), “input”, “output”, or “accessing” (for example, accessing data in a memory) is considered as “determining”. The term “determining” can include that “resolving”, “selecting”, “choosing”, “establishing”, “comparing”, or the like is considered as “determining.” Stated another way, “determining” can include that any kind of operation is considered as “determining.” The term “determining” may be replaced with “assuming”, “expecting”, “considering”, or the like.
(14) In the embodiment described above, in a case where “include”, “including”, and the transformation thereof are used, these terms are intended to be comprehensive in substantially the same manner as the term “comprising.” The term “or” used in the present disclosure is intended to not be exclusive OR.
(15) In the present disclosure, for example, in a case where an article, such as a, an, or the, is added, the present disclosure may include that nouns that follow these articles are plural.
(16) In the present disclosure, the description “A and B are different” may mean “A and B are different from each other.” The description may mean “each of A and B is different from C”. The terms “separated”, “coupled”, and the like may be construed in substantially the same manner as “different.”
(17) Respective aspects and embodiments described in the present disclosure may be used individually, may be combined and used, or may be switched and used according to execution. A report of predetermined information (for example, a report of “X”) is not limited to a report that is explicitly made, and may be implicitly made (for example, without making a report of the predetermined information).

### D. Aspects Derived from the Foregoing Embodiment and Modifications

The present disclosure has been described in detail; however, it is obvious to those skilled in the art that the present disclosure is not limited to the foregoing embodiment. The present disclosure can be implemented as modifications and variations without departing from the spirit and scope according to the present disclosure as defined by the descriptions in the claims. Description in the present disclosure is for illustrative purposes and is not of any restrictive significance for the present disclosure. The following aspects are derived from at least one of the foregoing embodiment and the modifications.

A three-dimensional data reduction apparatus according to a first aspect of the present disclosure reduces an amount of three-dimensional shape data representing a shape of a three-dimensional object. The three-dimensional data reduction apparatus includes an acquirer, a recognizer, a divider, and a reduction processor, described below. The acquirer acquires three-dimensional shape data representing a shape of a three-dimensional object. The recognizer recognizes a type of the object based on the three-dimensional shape data. The divider divides, based on the recognized type of the object, the three-dimensional shape data into subsets, each corresponding to one of the parts constituting the object. The reduction processor determines a data reduction amount of a subset for each of the parts, based on a table with reduction information representing a data reduction amount of each of the subsets, each corresponding to one of reference parts. Furthermore, the reduction processor reduces the amount of the three-dimensional shape data.

According to the three-dimensional data reduction apparatus according to the first aspect, a data reduction amount is determined for each part constituting an object, and fine reduction of the amount of shape data can be realized for each part. Furthermore, contents of the table are set based on an intended use of the shape data, that is, based on an application that will use the shape data. As a result, an optimal result of reduction for the application is obtained in view of the image quality and the reduction data amount. Trial and error, in which reduction of the shape data is repeated while the reduction data amount of each part is changed, is no longer needed.

In the three-dimensional data reduction apparatus according to a second aspect (an example of the first aspect) of the present disclosure, the data reduction amount of each of the subsets indicated by the reduction information is set based on a level of likelihood of the sightline of a user being placed on a corresponding part.

According to the three-dimensional data reduction apparatus of the second aspect, the data reduction amount can be finely set based on the likelihood of the sightline being placed on each of parts constituting an object to reduce a data amount of each part. Degradation of the image quality of an image displayed based on reduced shape data is less likely to be perceived.

In the three-dimensional data reduction apparatus according to a third aspect (an example of the first aspect) of the present disclosure, the reduction processor is configured to correct the divided plurality of subsets in accordance with a user instruction, determine a data reduction amount of a subset corresponding to each of the plurality of parts, and reduce the amount of the three-dimensional shape data.

According to the three-dimensional data reduction apparatus of the third aspect, the division result of the divider can be corrected to reduce the data amount for each part.

A non-transitory recording medium according to a fourth aspect of the present disclosure isa non-transitory recording medium having recorded therein a program that causes a computer to perform a method. The method includes: acquiring three-dimensional shape data representing a shape of a three-dimensional object; recognizing a type of the object based on the three-dimensional shape data; dividing, based on the recognized type of the object, the three-dimensional shape data into subsets, each corresponding to one of parts constituting the object; determining a data reduction amount of a subset for each of the parts, based on a table with reduction information representing a data reduction amount of each of the subsets, each corresponding to one of the parts, and reducing an amount of the three-dimensional shape data.

According to the recording medium of the fourth aspect, similarly to the first aspect, a reduction data amount is determined for each of parts constituting an object, and fine reduction of an amount of shape data can be realized for each part. Furthermore, contents of the table are set based on an intended use of the shape data, that is, based on an application that will use the shape data. As a result, an optimal result of reduction for the application is obtained in view of the image quality and the reduction data amount. Trial and error, in which reduction of the shape data is repeated while the reduction data amount of each part is changed, is no longer needed.

### DESCRIPTION OF REFERENCE SIGNS

10 . . . reduction apparatus, 110 . . . communication device, 120 . . . display device, 130 . . . input device, 140 . . . storage device, 150 . . . processing device, 150a . . . acquirer, 150b . . . recognizer, 150c . . . divider, 150d . . . reduction processor, 160 . . . bus, PR1 . . . program, MDL . . . recognition model, TBL1, TBL2 . . . parts table.

1. A three-dimensional data reduction apparatus comprising:
an acquirer configured to acquire three-dimensional shape data representing a shape of a three-dimensional object;
a recognizer configured to recognize a type of the object based on the three-dimensional shape data;
a divider configured to divide, based on the recognized type of the object, the three-dimensional shape data into a plurality of subsets, each corresponding to one of a plurality of parts constituting the object; and
a reduction processor configured to:
determine a data reduction amount of a subset for each of the plurality of parts, based on a table with reduction information representing a data reduction amount of each of the plurality of subsets, each corresponding to one of a plurality of reference parts; and
reduce an amount of the three-dimensional shape data.

2. The three-dimensional data reduction apparatus according to claim 1,
wherein the data reduction amount of each of the plurality of subsets indicated by the reduction information is set based on a level of likelihood of sightline of a user being placed on a corresponding part.

3. The three-dimensional data reduction apparatus according to claim 1,
wherein the reduction processor is configured to:
correct the divided plurality of subsets in accordance with a user instruction;
determine a data reduction amount of a subset corresponding to each of the plurality of parts; and
reduce the amount of the three-dimensional shape data.

4. A non-transitory recording medium having recorded therein a program that causes a computer to perform a method, the method comprising:
acquiring three-dimensional shape data representing a shape of a three-dimensional object;
recognizing a type of the object based on the three-dimensional shape data;
dividing, based on the recognized type of the object, the three-dimensional shape data into a plurality of subsets, each corresponding to one of a plurality of parts constituting the object;
determining a data reduction amount of a subset for each of the plurality of parts, based on a table with reduction information representing a data reduction amount of each of the plurality of subsets, each corresponding to one of a plurality of parts, and reducing an amount of the three-dimensional shape data.
